(19) United States
(12) Patent Application Publication
(10) Pub. No.: US 2026/0270116 A1
(43) Pub. Date: Sep. 10, 2026

(54) TIME-DOMAIN-BASED CHANNEL ESTIMATION IN ORTHOGONAL FREQUENCY DIVISION MULTIPLEXING (OFDM) SYSTEMS

(71) Applicant: Samsung Electronics Co., Ltd., Suwon-si (KR)

(72) Inventors: Van Thuy Nguyen, Plano, TX (US); Yang Li, Plano, TX (US)

(21) Appl. No.: 19/544,881

(22) Filed: Feb. 19, 2026

Related U.S. Application Data
(60) Provisional application No. 63/766,910, filed on Mar. 4, 2025.

(51) Int. Cl. H04L 25/02

(52) U.S. Cl. CPC H04L 25/0224; H04L 25/0256

(57) ABSTRACT

Methods and apparatuses for time-domain-based channel estimation in OFDM systems in wireless communication systems. The method of a base station comprises: receiving, from a user equipment (UE) via a set of antennas, uplink signals including at least one of sounding reference signals (SRSs) or demodulation reference signals (DMRs); identifying time-domain channel estimation (TDCE) for each of the uplink signals, wherein a noise power is estimated to identify the TDCE; removing a noise floor from the identified TDCE; and performing, based on the estimated noise power and an estimated signal-to-noise ratio (SNR), an operation to obtain normalized mean square error (NMSE) for the TDCE.

### CROSS-REFERENCE TO RELATED APPLICATIONS AND CLAIM OF PRIORITY

The present application claims priority to U.S. Provisional Patent Application No. 63/766,910, filed on Mar. 4, 2025. The contents of the above-identified patent documents are incorporated herein by reference.

### TECHNICAL FIELD

The present disclosure relates generally to wireless communication systems and, more specifically, the present disclosure relates to time-domain-based channel estimation in orthogonal frequency division multiplexing (OFDM) systems in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to time-domain-based channel estimation in OFDM systems in wireless communication systems.

In one embodiment, a base station (BS) in a wireless communication system is provided. The BS comprises a transceiver configured to receive, from a user equipment (UE) via a set of antennas, uplink signals including at least one of sounding reference signals (SRSs) or demodulation reference signals (DMRs). The BS further comprises a processor operably coupled to the transceiver, the processor configured to: identify time-domain channel estimation (TDCE) for each of the uplink signals, wherein a noise power is estimated to identify the TDCE, remove a noise floor from the identified TDCE, and perform, based on the estimated noise power and an estimated signal-to-noise ratio (SNR), an operation to obtain normalized mean square error (NMSE) for the TDCE.

In another embodiment, a method of a BS in a wireless communication system is provided. The method comprises: receiving, from a UE via a set of antennas, uplink signals including at least one of SRSs or DMRs; identifying TDCE for each of the uplink signals, wherein a noise power is estimated to identify the TDCE; removing a noise floor from the identified TDCE; and performing, based on the estimated noise power and an estimated SNR, an operation to obtain NMSE for the TDCE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates a flowchart of method of a gNB for channel estimation according to various embodiments of the present disclosure;

FIG. 8 illustrates an example of CS sequences separated in a delay domain according to various embodiments of the present disclosure;

FIG. 9 illustrates examples of time domain CE architecture according to various embodiments of the present disclosure;

FIG. 10 illustrates an example of noise estimation by windowing according to various embodiments of the present disclosure;

FIG. 11 illustrates an example of target UE window design according to various embodiments of the present disclosure;

FIG. 12 illustrates an example of target UE after applying CS removal according to various embodiments of the present disclosure;

FIG. 13 illustrates an example of Cirshift operation after cs removal windowing according to various embodiments of the present disclosure;

FIG. 14 illustrates an example of target UE after applying CS removal and time compensation according to various embodiments of the present disclosure;

FIG. 15 illustrates an example of adaptive window design according to various embodiments of the present disclosure;

FIG. 16 illustrates an example of AI model according to various embodiments of the present disclosure; and

FIG. 17 illustrates a flowchart of a method for time-domain-based channel estimation in OFDM systems according to various embodiments of the present disclosure.

### DETAILED DESCRIPTION

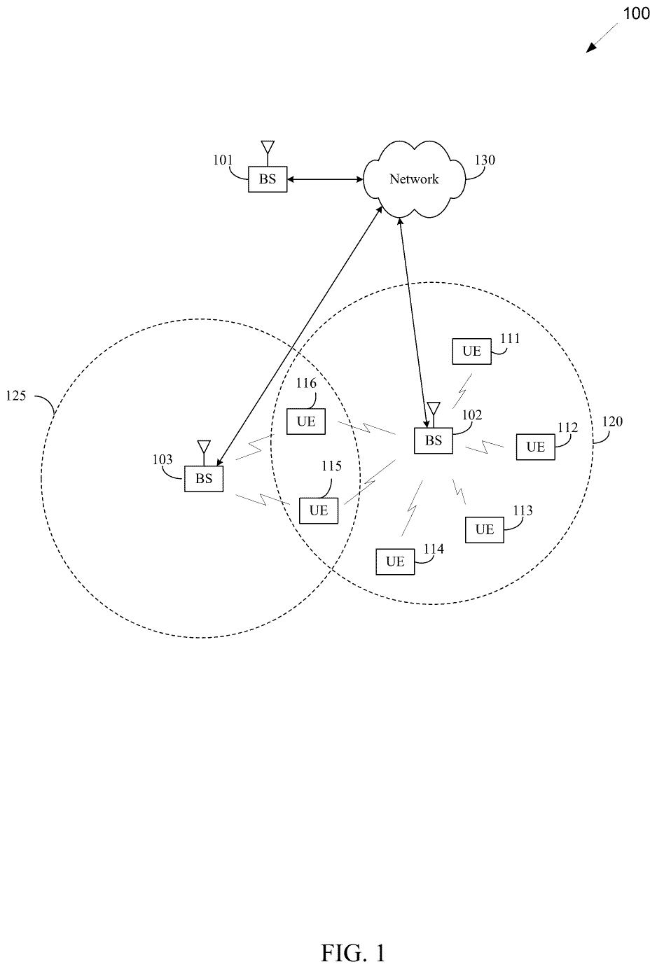

FIG. 1 through FIG. 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 36.211 v16.4.0, “E-UTRA, Physical channels and modulation”; 3GPP TS 36.212 v16.4.0, “E-UTRA, Multiplexing and Channel coding”; 3GPP TS 36.213 v16.4.0, “E-UTRA, Physical Layer Procedures”; 3GPP TS 36.321 v16.3.0, “E-UTRA, Medium Access Control (MAC) protocol specification”; 3GPP TS 36.331 v16.3.0, “E-UTRA, Radio Resource Control (RRC) Protocol Specification”; 3GPP TS 38.211 v16.4.0, “NR, Physical channels and modulation”; 3GPP TS 38.212 v16.4.0, “NR, Multiplexing and Channel coding”; 3GPP TS 38.213 v16.4.0, “NR, Physical Layer Procedures for Control”; 3GPP TS 38.214 v16.4.0, “NR, Physical Layer Procedures for Data”; 3GPP TS 38.215 v16.4.0, “NR, Physical Layer Measurements”; 3GPP TS 38.321 v16.3.0, “NR, Medium Access Control (MAC) protocol specification”; and 3GPP TS 38.331 v16.3.1, “NR, Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting time-domain-based channel estimation in OFDM systems, at a gNB 101-103, in wireless communication systems. In certain embodiments, and one or more of the gNBs 101-103 includes circuitry, programing, or a combination thereof, to support to time-domain-based channel estimation in OFDM systems in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

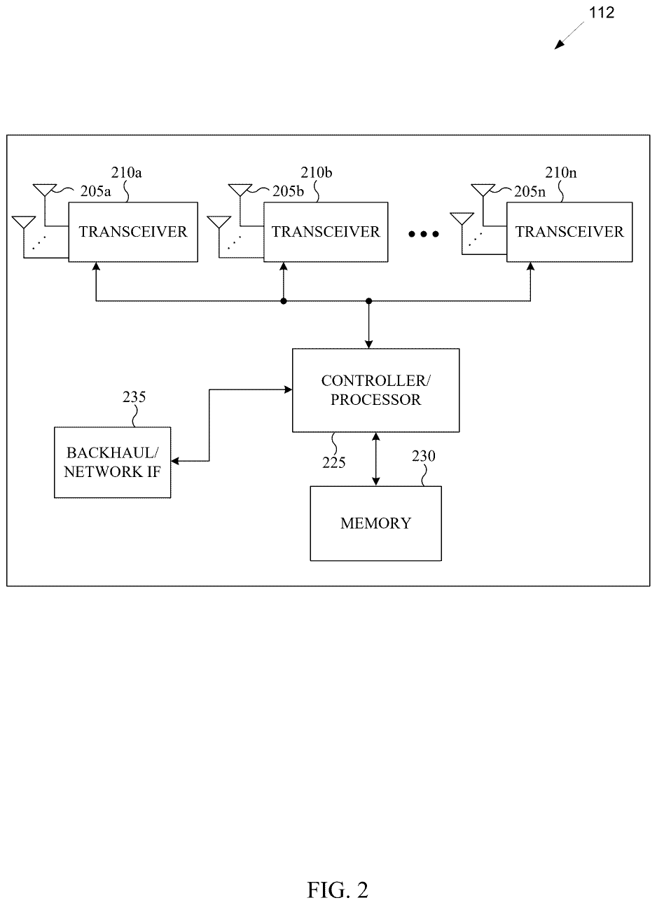

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support time-domain-based channel estimation in OFDM systems in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

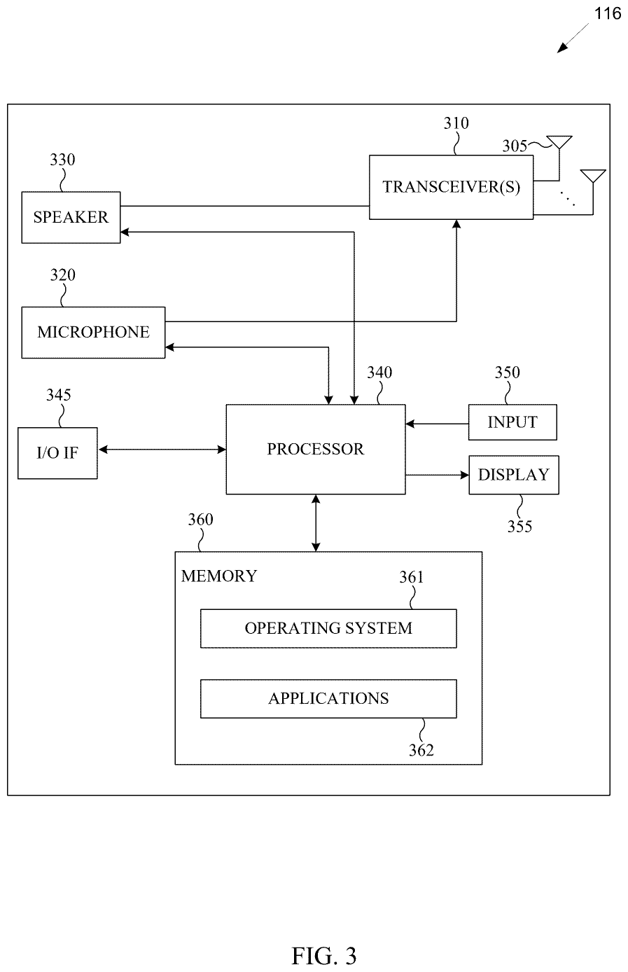

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting time-domain-based channel estimation in OFDM systems, at the gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

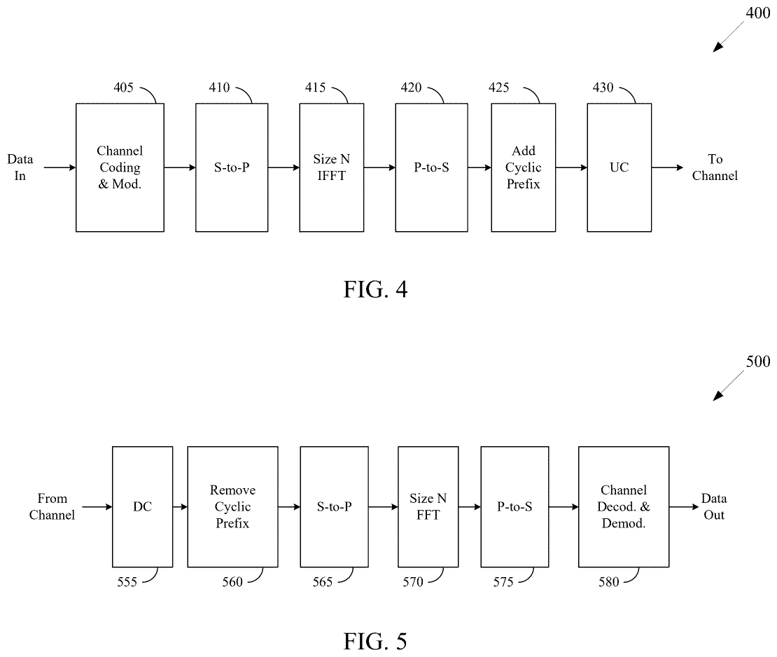

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency and removes cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architecture can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including reference signal (RS) CSI-RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

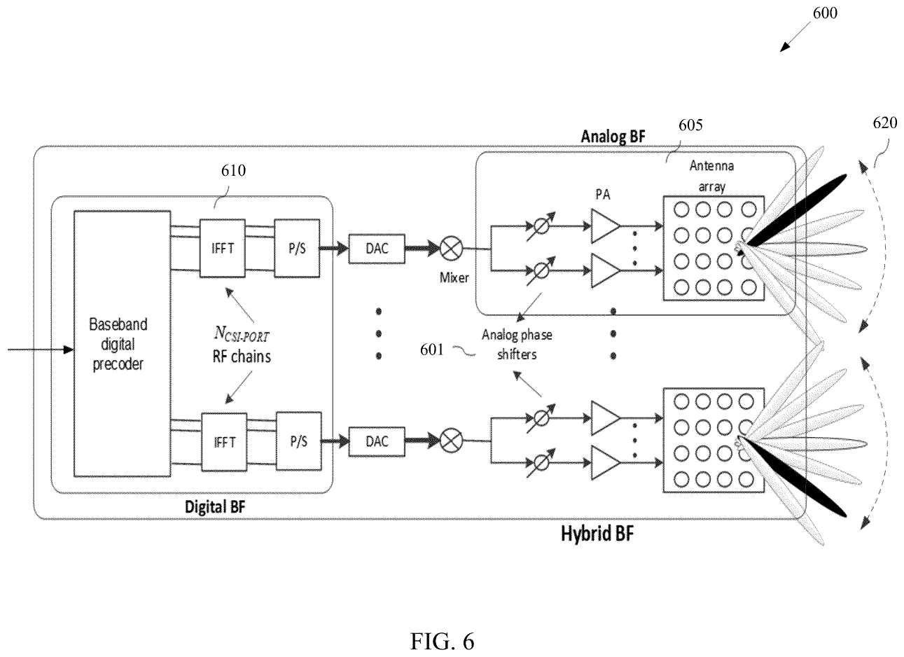

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (~10 dB additional loss at 100 m distance), larger number of and sharper analog beams (hence larger number of radiators in the array) may compensate for the additional path loss.

For a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size for a carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) cannot be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

In TDD, a common approach to acquire DL channel state information is to exploit UL channel estimation through receiving UL RSs (e.g., SRS) from a UE. By using the channel reciprocity in TDD systems, the UL channel estimation itself can be used to infer DL channels. This favorable feature enables a network (NW) to reduce the training overhead significantly. Thus, in a gNB, channel estimation (CE) is critical for achieving high spectral efficiency and reliable cell coverage, as the estimated channel state information (CSI) is used for many operations. Thus, in a gNB, channel estimation (CE) is one of key technologies for achieving high spectral efficiency and reliable cell coverage, as the estimated accurate channel state information (CSI) is used for many signal processing operations in NW.

There are two types of channel estimation: (i) SRS-based CE and (ii) DMRS CE. SRS-based CE is implemented in a gNB, which relies on the sounding reference signal (SRS) to estimate the CSI in a time division duplex (TDD) system, and uses it to perform scheduling and beamforming weight calculation. DMRS CE is used for an uplink (UL) data reception, where the gNB obtains the CSI via demodulation reference signals (DMRS), and uses it for equalization.

The CE typically can comprise two stages of operation: (i) a noisy estimate is obtained by removing the reference signals (RS); and (ii) the noisy estimate is refined before it can be used in subsequent modules or processing.

The refinement stage or CE may be key and may usually require carefully designed algorithms. In some embodiments of a signal processing, the MMSE estimator is optimal in the sense of the mean square error (MSE). The MMSE estimator exploits the second order channel statistics such as the covariance and cross-correlation matrices, and SNR/noise power. However, these statistics are usually difficult to calculate, due to: (i) the pilots/RS are transmitted sparsely in a time and frequency domain; (ii) the RS can display varying SNR due to power control and environment change; and (iii) the channel can experience non-stationarity especially in a mobility scenario.

As a result, the MMSE is computationally expensive to deploy in commercial systems. Thus, good performance and low complexity CE algorithms are important for practical NR systems.

Various embodiments of the present disclosure addresses one or more problems of channel estimation that includes how to effectively suppressive multi-user interference (MUI) in the CE process. A frequency based MUI removal methods produce residual errors that are difficult to compensate for an advanced signal processing technique. The un-avoided reducible MUI errors substantially degrade the CE performance, i.e., high NMSE error floor CE at the high SNR regime or at high CS level, i.e., CS-4 or CS-8.

Various embodiments of the present disclosure provides an efficient CE method in a time domain that has good performance in a wide range of channel profiles. First, a correct estimate noise power is provided. Then by removing a noise floor, and by applying threshold based adaptive time windowing method, the provided time domain CE algorithm produces robust NMSE performance in wide channel profiles and different CS scenarios, such as CS-4, CS-8: providing time-domain channel estimation (CE) for improving normalized mean square error (NMSE) performance, including estimating noise power, removing a noise floor, and applying threshold-based adaptive time windowing.

For providing accurate noise power, SNR estimations that can be utilized for CE as well as different signal processing blocks in MIMO systems.

For providing threshold-based adaptive time domain windowing to correctly detect the true channel signals in a wide range of channel and noise conditions for improving NMSE performance.

Although various embodiments of this disclosure relate to 3GPP 5G NR communication systems, other embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

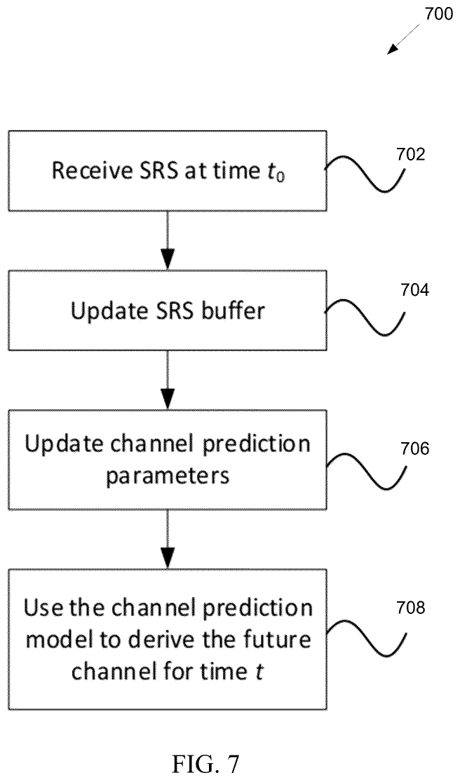

FIG. 7 illustrates a flowchart of a method of a gNB 700 for channel estimation according to various embodiments of the present disclosure. The method 700 may be performed by a network entity (e.g., base station, 101-103 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, a gNB receives SRS in step 702. In step 704, the gNB updates an SRS buffer. Subsequently, in step 706, the gNB updates channel prediction parameters. Finally, the gNB in step 708 muses the channel prediction model to derive the future channel.

The present disclosure provides a simple yet effective filtering-based CE algorithm that can not only suppress the MUI interference significantly but also provides a good de-noising CE performance in wireless networks.

In an OFDM system, for an arbitrary user at one snapshot, \hat{x}(m) is the transmitted RS pilot at the m—the subcarrier; and yₖ(m) is the received signal at the corresponding resource, on the k-th gNB antenna element. The first step of channel estimation is to apply the least square (LS) algorithm to remove the RS and obtain the initial noisy estimate as shown in equation 1.

$${\hat{h}}_{k} ( m ) = {y}_{k} ( m ) / \hat{x} ( m ) \qquad ( 1 )$$

Note that multiple users can be multiplexed on the same time-frequency resource by the Zadoff-Chu (ZC) sequence and cyclic shift (CS), hence yₖ(m) contains other user's channel information, in addition to being impaired by varying noise. Therefore, the estimated channel ĥₖ(m) may be further refined before it can be applied for transmission or reception. For a single snapshot of the channel, the goal is to obtain a refined channel estimate \hat{ĥ}ₓ(m) as close as possible to the ground truth channel hₖ(m).

The channel model is given as shown in equation (2).

$$y ( n ) = {h}_{1} ( n ) {e}^{j {α}_{1} n} + … + {h}_{K} ( n ) {e}^{j {α}_{k} n} \qquad ( 2 )$$

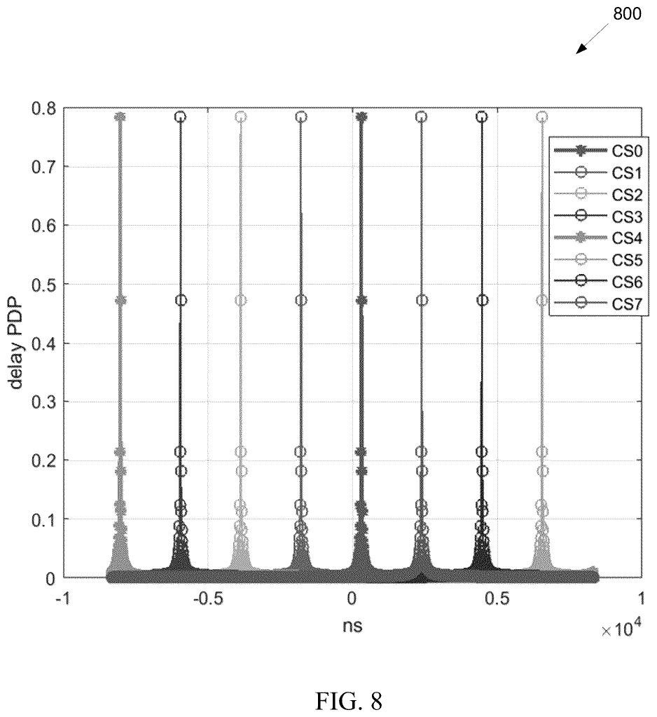

In equation (2), hᵢ(n) is a channel of user i, i=1, . . . , K. In SRS modelling, each UE is separated by orthogonal cyclic sequence (CS) αᵢ. The orthogonality visualization of different CS sequences is illustrated in FIG. 8.

FIG. 8 illustrates an example of CS sequences separated in a delay 800 domain according to various embodiments of the present disclosure. An embodiment of the CS sequences separated in a delay 800 shown in FIG. 8 is for illustration only.

To get the MUI removal, a matrix inversion of equivalent CS matrix is provided as shown in equations (3) and (4).

First, Normalize by 1^{st} CS:

$${y}^{′} ( n ) = y ( n ) / {e}^{j {α}_{1} n} \qquad ( 3 )$$

$$\to {y}^{′} ( n ) = {h}_{1} ( n ) + … + {h}_{K} ( n ) {e}^{j ( {α}_{k} - {α}_{1} ) n}$$

Then remove MUI:

$${y}^{′} ( n ) = {h}_{1} ( n ) + … + {h}_{k} ( n ) {e}^{j ( {α}_{k} - {α}_{1} ) n} + {h}_{K} ( n ) {e}^{j ( {α}_{K} - {α}_{1} ) n} \qquad ( 4 )$$

$${y}^{′} ( n + 1 ) = {h}_{1} ( n ) + … + {h}_{k} ( n ) {e}^{j ( {α}_{k} - {α}_{1} ) ( n + 1 )} + {h}_{K} ( n ) {e}^{j ( {α}_{K} - {α}_{1} ) ( n + 1 )}$$

$${y}^{′} ( n + K - 1 ) = {h}_{1} ( n ) + … + {h}_{k} ( n ) {e}^{j ( {α}_{k} - {α}_{1} ) ( n + K - 1 )} + {h}_{K} ( n ) {e}^{j ( {α}_{K} - {α}_{1} ) ( n + K - 1 )}$$

$$\to [ \begin{matrix}{h\_est}_{1} ( n ) \\ ⋮ \\ {h\_est}_{k} ( n ) \\ ⋮ \\ {h\_est}_{K} ( n )\end{matrix} ] = {[ \begin{matrix}1 … {e}^{j ( {α}_{k} - {α}_{1} ) n} … {e}^{j ( {α}_{K} - {α}_{1} ) n} \\ ⋱ \\ 1 … {e}^{j ( {α}_{k} - {α}_{1} ) ( n + 1 )} … {e}^{j ( {α}_{K} - {α}_{1} ) ( n + 1 )} \\ ⋱ \\ 1 … {e}^{j ( {α}_{k} - {α}_{1} ) ( n + K )} … {e}^{j ( {α}_{K} - {α}_{1} ) ( n + K )}\end{matrix} ]}^{- 1} [ \begin{matrix}{y}^{′} ( n ) \\ ⋮ \\ {y}^{′} ( n + k - 1 ) \\ ⋮ \\ {y}^{′} ( n + K - 1 )\end{matrix} ]$$

FIG. 8 illustrates CS sequences that are separated in delay domain. Based on this, a filter-based CE design is provided in the present disclosure.

In some cases, there can be CE solutions to handle MUI interference: (i) in a frequency domain and (ii) in a time domain.

In a frequency domain, commercial systems usually implement moving average (MA) as CE after MUI removal step. This MUI removal is implemented by using put at small NULL at the interference location (by implementing inversion matrix as in equation (4) to get a high residual error floor at high SNR regime.

In a time domain, first, accurate noise power is estimated. Then, MUI removal is separated in a time domain using a fixed/adaptive window. Since the channel energy is concentrated within a portion of time domain region, an interference region can be separated using a simple adaptive widowing method. However, how to get design adaptive windowing to remove MUI effectively and how to estimate noise accurately in the high multiplexing scenarios, such as CS-4 and/or CS-8 are provided in the present disclosure.

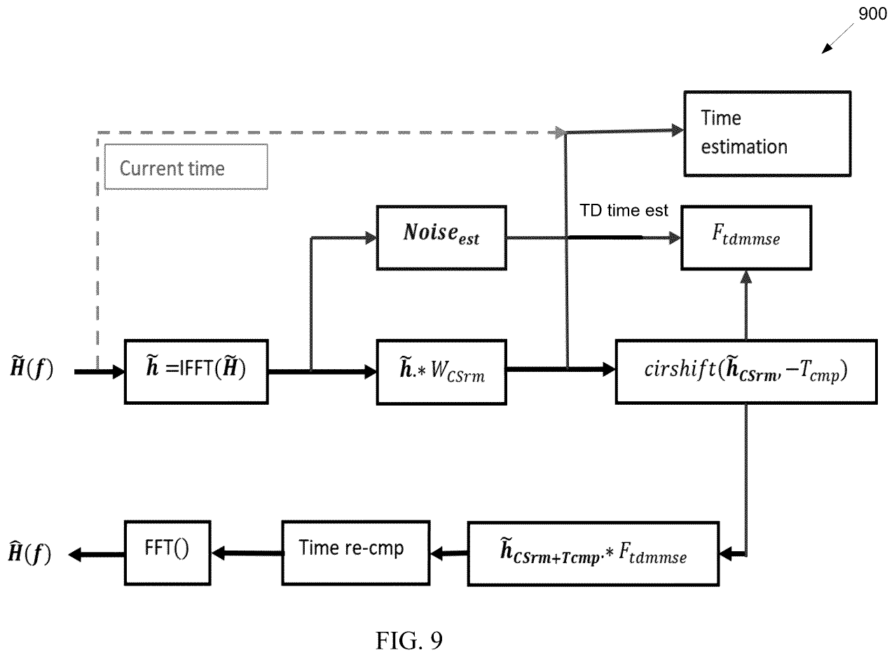

FIG. 9 illustrates examples of time domain CE architecture 900 according to various embodiments of the present disclosure. An embodiment of the time domain CE architecture 900 shown in FIG. 9 is for illustration only.

An example overall provided CE architecture is illustrated in FIG. 9, which describes the basic blocks in a CE algorithm flow. In which time offset is estimated from the noisy SRS channels. After that the channels are time compensated, then goes through the channel estimation blocks. Finally, the estimated channels are re-time compensation again to return the actual channel time offsets.

Assuming a system operates over a bandwidth of N_{W} REs, with Nᵣ receive antenna, with N_{CS} UEs cyclic-shift multiplexing. For example, the normal SRS configuration of 68 RBs or 25 MHz bandwidth, 64 antenna, comb-2, CS-2 then

$${N}_{w} = \frac{12 * 68}{4} = 204 , {N}_{r} = 64 , {N}_{CS} = 2 .$$

FIG. 11 illustrates an example of target UE window design 1100 according to various embodiments of the present disclosure. An embodiment of the target UE window design 1100 shown in FIG. 11 is for illustration only.

In the present disclosure, basic processing steps are provided in TABLE 1.

TABLE 1
Processing step

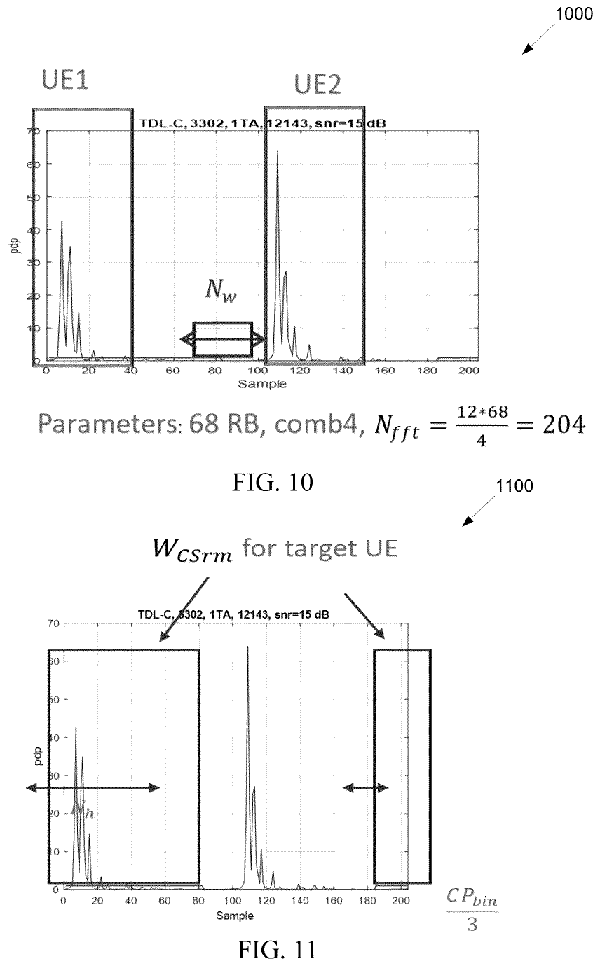

```
Get: hₜ = ifft(H_{f}) is time domanin pdp of the channel, where N_{FFT} = N_{w}
$Get joint pdp of the channel : pdp = \frac{1}{{N}_{r}} {\sum }_{i = 1}^{{N}_{r}} {\vert {h}_{t} ( i ) \vert}^{2}$
Step 1: TD noise estimation
With CS-2, channel pdp concentrates on N_{cs} = 2 delay regions of two UEs
$As shown in FIG . 8 , each UE may span on \frac{{N}_{FFT}}{{N}_{CS}} . By using circular shift operation , the target UE$
(shown as UE1) is moved near 0 region:
  $( a ) UE - 1 pdp lies from [ 0 : \frac{{N}_{fft}}{2} - 1 ] or [ 0 : 101 ]$
There are two available noise estimate methods:
  (b) Method 1: Finding noise locations shown in FIG. 10.
    $i . Determine noise window length : {N}_{w} = \frac{{N}_{FFT}}{2 * {N}_{CS}} = ⌈ \frac{102}{4} ⌉ = 26 samples$
    ii. Determine a window, starting from location loc : W_{loc} = [loc: loc + N_{w}]
    $iii . {Noise}_{t} = {min}_{loc = \frac{{N}_{FFT}}{2 * {N}_{cs}} {N}_{w} : \frac{{N}_{FFT}}{{N}_{cs}}} {\sum }_{{W}_{loc}} pdp$
    $iv . {Noise}_{Est} = \frac{{Noise}_{t}}{{N}_{w}}$
  (c) Method 2: Estimate noise power by ordering method.
    $i . Determine noise window length : {N}_{w} = \frac{{N}_{FFT}}{α * {N}_{CS}} samples , where α ∈ [ 1 : 2 ]$
      is optimized factor to get more accurate noise power.
    ii. pdp_{order} = asendingorder(pdp)
    $iii . {Noise}_{Est} = \frac{{\sum }_{i = 1}^{{N}_{w}} {pdp}_{order} ( i )}{{N}_{w}}$
Step 2: TD SNR estimation
Estimated SNR is an important parameter for many other processing modules in the receiver
architecture. To get SNR estimation, there are two main steps: (1) extract target signal portion;
and (2) get the signal power after subtracting the noise power (estimated in the Step 1).
```

FIG. 10 illustrates an example of noise estimation by windowing 1000 according to various embodiments of the present disclosure. An embodiment of the noise estimation by windowing 1000 shown in FIG. 10 is for illustration only.

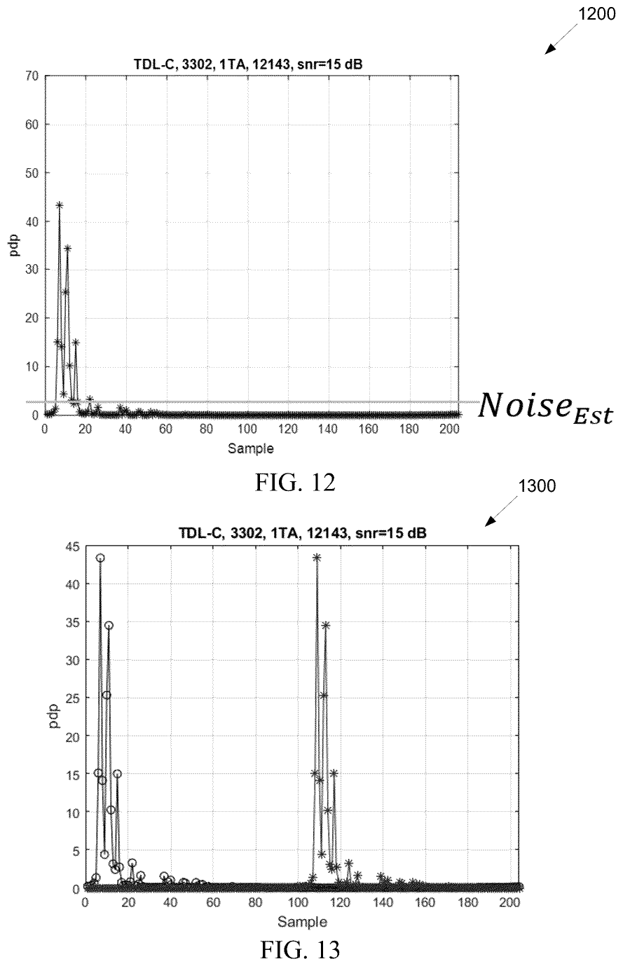

FIG. 12 illustrates an example of target UE after applying CS removal 1200 according to various embodiments of the present disclosure. An embodiment of the target UE after applying CS removal 1200 shown in FIG. 12 is for illustration only.

FIG. 13 illustrates an example of Cirshift operation after cs removal windowing 1300 according to various embodiments of the present disclosure. An embodiment of the Cirshift operation after cs removal windowing 1300 shown in FIG. 13 is for illustration only.

It may not be straightforward how to extract the target signal portion due to the timing offset incurred within channels and long delay paths. However, due to a time-domain and CS sequence properties, each UE may concentrate on a separate region as shown in FIG. 8. When a target UE (moved near 0 bin) is processed, there are two window regions: (i) a head region and (ii) a tail region. The tail region existed because of DFT leakage effects after analog-to-digital conversion (ADC) and DFT processing. The TD CS removal window is designed in the following steps in TABLE 2.

TBALE 2
A design of TD CS removal window

```
  $( a ) Number of valid delay domain points for target UE : {N}_{UE} = \frac{{N}_{fft}}{{N}_{CS}} = \frac{204}{2} = 102$
  (b) Number of cyclic prefix (CP) bins scaled with LTE parameters (CP samples =
    $144 , in 2048 FFT size ) is {CP}_{bin} = ⌈ \frac{144 * 12 * 68}{2048} ⌉ = 58 bins$
$( c ) Assume that the tail window is \frac{{CP}_{bin}}{α} , α is an optimized parameter . In the$
    present disclosure, α = 3 is used in our illustrate figures.
$( d ) The head window length is {N}_{h} = {N}_{UE} - \frac{{CP}_{bin}}{α}$
$( e ) The CS removal window is defined as {W}_{CSrm} ( i ) = \{ \begin{matrix}1 , if i = 1 , … , {N}_{h} \\ 0 , if i = {N}_{h} + 1 , … , {N}_{h} + {N}_{UE} \\ 1 , if i = {N}_{h} + {N}_{UE} + 1 : {N}_{fft}\end{matrix}$
```

The present disclosure includes (i.e., but is not limited to) two methods to estimate SNR, as shown in TABLE 3.

TBALE 3
SNR estimation methods

```
Method 1:
    (a) pdp_{csrm} = pdp.* W_{CSrm}
    $( b ) {pdp}_{csrm} = \{ \begin{matrix}{pdp}_{CSrm} - {Noise}_{est} , if {pdp}_{CSrm} > {Noise}_{est} \\ 0 , otherwise\end{matrix}$
    $( c ) {S}_{total} = {\sum }_{i = 0}^{{N}_{fft} - 1} {pdp}_{csrm}$
    (d) S = Sₜₒₜₐₗ/N_{fft}
    $( e ) {SNR}_{est} = \frac{S}{{Noise}_{est}}$
Method 2:
Get CS-1 time domain signal: \tilde{h}_{CSrm} = hₜ.* W_{CSrm}
From W_{CSrm}, recover CS-1 frequency domain \tilde{H}_{CS1} = FFT{\tilde{h}_{CSrm}}
$Signal power S = {\sum }_{i = 0}^{{N}_{fft} - 1} {‖ {\tilde{H}}_{CS 1} ( i ) ‖}^{2} - {Noise}_{est}$
      ${SNR}_{est} = \frac{S}{{Noise}_{est}}$
```

In the present disclosure, further basic processing steps are provided in TABLE 4.

TABLE 4
Further basic processing steps

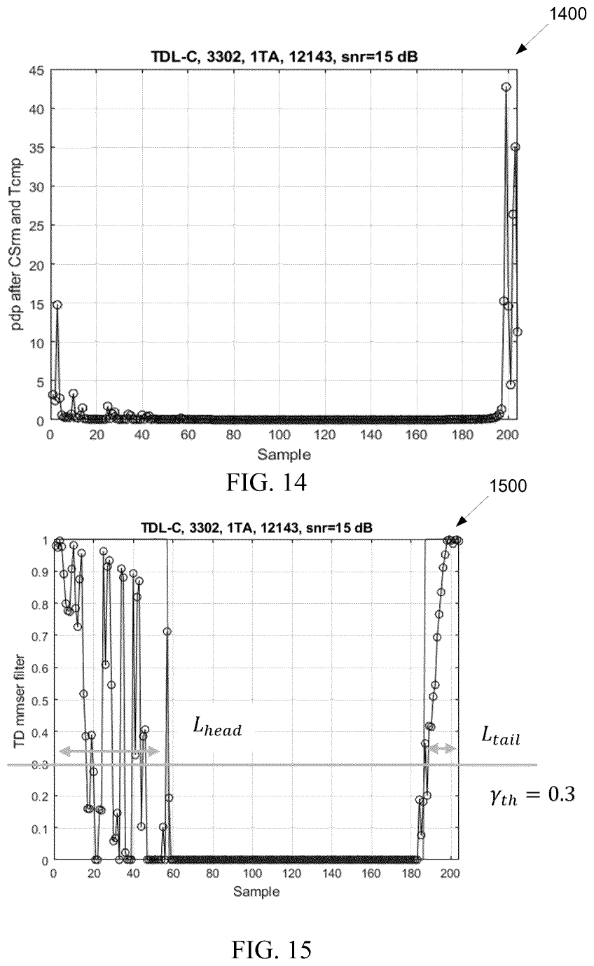

```
Step 3: TO estimation
Shift to center: pdpₛ = fftshift(pdp_{csrm})
Get central point of the signal
    $i . {T}_{c} = \frac{{\sum }_{i = 1}^{{N}_{fft}} i * {pdp}_{s} ( i )}{{\sum }_{i = 1}^{{N}_{fft}} {pdp}_{s} ( i )}$
    $ii . {T}_{cmp} = {T}_{c} - \frac{{N}_{fft}}{2}$
Timing compensation: \tilde{h}_{CSrm+Tcmo} = cirshift(\tilde{h}_{CSrm}, − T_{cmp})
    pdp_{CSrm+Tcmp} = cirshift(pdp_{CSrm}, − T_{cmp}
Step 4: TD mmse filter
The final step is to design an effective time domain MMSE
filter as follows
Let pdp1 = pdp_{CSrm+Tcmp} shown in FIG. 14.
$TD mmse filter : {F}_{mmse} = \{ \begin{matrix}\frac{pdp 1 - {Noise}_{est}}{pdp 1} , pdp 1 \geq {Noise}_{est} \\ 0 , otherwise\end{matrix}$
From Step 2, only rough CS removal window design to remove the
UE interference signals based on the N_{cs} parameter. However, one
critical final step is to determine accurately the locations of the
target UE signal.
```

FIG. 14 illustrates an example of target UE after applying CS removal and time compensation 1400 according to various embodiments of the present disclosure. An embodiment of the target UE after applying CS removal and time compensation 1400 shown in FIG. 14 is for illustration only.

FIG. 15 illustrates an example of adaptive window design 1500 according to various embodiments of the present disclosure. An embodiment of the adaptive window design 1500 shown in FIG. 15 is for illustration only.

In the present disclosure, an adaptive NMSE windowing is provided in TABLE 5 to determine accurately the location of the target UE signal as shown in FIG. 15.

TABLE 5
NMSE windowing

```
  (a) First portion: last sample in first half that Fₘₘₛₑ ≥ γₜₕ
    ${L}_{head} = {max}_{i} {F}_{nmse} ( i ) \geq {γ}_{th} , i \geq {K}_{m ax}$
        $if {L}_{head} = ∅ , {L}_{head} = \frac{{K}_{m ax}}{β}$
  (b) Last portion: first sample in second half that F_{tdmmse} ≥ γₜₕ
    ${L}_{tail} = {max}_{i} {F}_{nmse} ( i ) \geq {γ}_{th} , i \geq {N}_{FFT} - {K}_{m ax}$
        $if {L}_{tail} = ∅ , {L}_{tail} = \frac{{K}_{m ax}}{β}$
  (c) Tunable setting parameters based on channel conditions.
    Below setting was studied from TDL-C channel
    i. SNRₑₛₜ ≤ 0 dB: γₜₕ = 0.4, K = 2
    ii. 0 dB < SNRₑₛₜ ≤ 10 dB: γₜₕ = 0.3, K = 2.5
    iii. 10 dB < SNRₑₛₜ: γₜₕ = 0.7, K = 1
    iv. Kₘₐₓ = K * CP_{bin}; β = 6
  (d) The refinement window is defined as
      $\begin{matrix}{W}_{ref} ( i ) = \{ \begin{matrix}1 , if i = 1 , … , {L}_{head} \\ 0 , if i = {L}_{head} + 1 , … , {N}_{fft} - {L}_{tail} \\ 1 , if i = {N}_{fft} - {L}_{tail} + 1 : {N}_{fft}\end{matrix} \\ {F}_{tdmmse} = {F}_{mmse} * {W}_{ref}\end{matrix}$
W_{ref} is the above step, mostly based on our large experiments and
deep domain knowledge insights. The above insights are also
used to train a small AI model learn W_{ref} directly, with a
$NMSE loss function as Loss = \frac{{‖ \hat{F} - F ‖}^{2}}{{‖ F ‖}^{2}} as described in FIG . 16.$
Once trained with many channels, noise conditions and multiuser
scenarios, a simple model can help to produce a reliable and robust
channel estimation
```

In the present disclosure, further basic processing steps are provided in TABLE 6.

TABLE 6
Further basic processing steps
Step 5: Applying TD NMSE filter

```
Time domain denosing channel is
  \tilde{h}_{td} = h_{CSrm+Tcmp} * F_{tdnmse}
Time recompensation
  h_{td, out} = cirshift(\tilde{h}_{td}, T_{cmp})
The frequency domain channel estimation output
    \tilde{H} = FFT(h_{td,out})
```

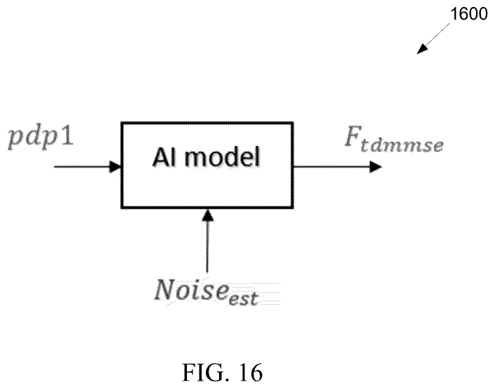

FIG. 16 illustrates an example of AI model 1600 according to various embodiments of the present disclosure. An embodiment of the AI model 1600 shown in FIG. 16 is for illustration only.

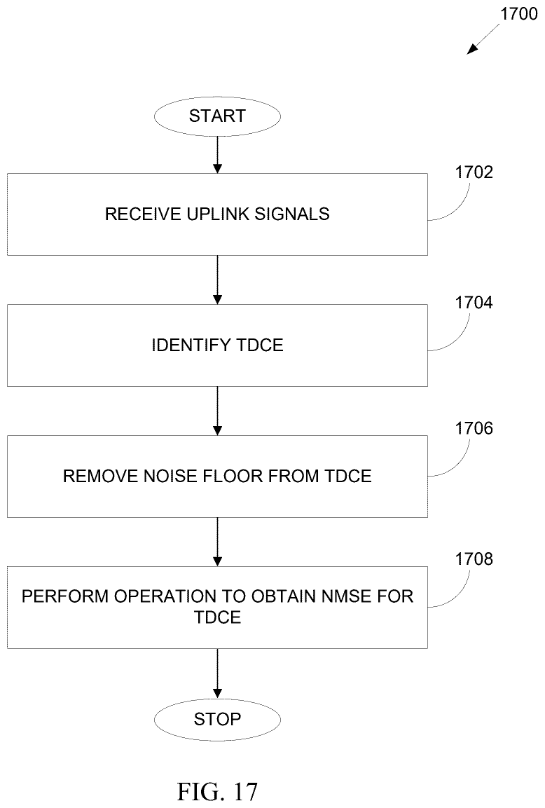

FIG. 17 illustrates a flowchart of a method 1700 for time-domain-based channel estimation in OFDM systems according to various embodiments of the present disclosure. The method 1700 may be performed by a BS (e.g., 101-103 as illustrated in FIG. 1). An embodiment of the method 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As illustrated in FIG. 17, the method 1700 begins at step 1702. In step 1702, a BS receives, from a UE via a set of antennas, uplink signals including at least one of SRSs or DMRs.

Subsequently, in step 1704, the BS identifies TDCE for each of the uplink signals, wherein a noise power is estimated to identify the TDCE.

Next, in step 1706, the BS removes a noise floor from the identified TDCE.

Finally, in step 1708. The BS performs, based on the estimated noise power and an estimated SNR, an operation to obtain NMSE for the TDCE.

In one embodiment, the BS performs a threshold-based adaptive TD windowing operation for the identified TDCE after removing the noise floor from the identified TDCE.

In one embodiment, the BS detects, based on the threshold-based adaptive TD windowing operation, a channel signal location in a wide range channel with a noise.

In one embodiment, the BS identifies a channel coefficient based on a threshold associated with a length of an adaptive window for the threshold-based adaptive TD windowing operation.

In one embodiment, the BS estimates, based on the noise power, the SNR for each of the TDCE using a plurality of parallel signal processing functional blocks in MIMO systems.

In one embodiment, the BS determines a noise window length, determines, based on the noise window length, a window to identify a noise location, and estimates a TD noise of a noise identified in the window.

In one embodiment, the BS identifies a pdp vector, identifies a noise window length using a coefficient associated with a noise power, identifies, based on the noise window length, the pdp vector in an ascending order, and estimates a TD noise of a noise identified based on the noise window length and the ascending ordered pdp vector.

In one embodiment, the BS shifts the pdp vector to a center position in an FFT shift operation to estimate a TO value and compensates, based on the estimated TO value, a pdp.

In one embodiment, the BS removes, a noise power based on a refinement window. In such embodiment, the refinement window is identified based on a last sample in a first half (L_{head}) and a first sample in a second half (N_{fft}−Lₜₐᵢₗ).

In one embodiment, the BS enables, based on the refinement window, an artificial intelligence (AI) functional entity using a pdp vector and the estimated noise power and identifies, based on the AI functional entity, a TD MMSE filter.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the claims appended. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive, from a user equipment (UE) via a set of antennas, uplink signals including at least one of sounding reference signals (SRSs) or demodulation reference signals (DMRs); and
a processor operably coupled to the transceiver, the processor configured to:
identify time-domain channel estimation (TDCE) for each of the uplink signals, wherein a noise power is estimated to identify the TDCE,
remove a noise floor from the identified TDCE, and
perform, based on the estimated noise power and an estimated signal-to-noise ratio (SNR), an operation to obtain normalized mean square error (NMSE) for the TDCE.

2. The BS of claim 1, wherein the processor is further configured to perform a threshold-based adaptive TD windowing operation for the identified TDCE after removing the noise floor from the identified TDCE.

3. The BS of claim 2, wherein the processor is further configured to detect, based on the threshold-based adaptive TD windowing operation, a channel signal location in a wide range channel with a noise.

4. The BS of claim 2, wherein the processor is further configured to identify a channel coefficient based on a threshold associated with a length of an adaptive window for the threshold-based adaptive TD windowing operation.

5. The BS of claim 1, wherein the processor is further configured to estimate, based on the noise power, the SNR for each of the TDCE using a plurality of parallel signal processing functional blocks in multi-input multi-output (MIMO) systems.

6. The BS of claim 1, wherein the processor is further configured to:
determine a noise window length;
determine, based on the noise window length, a window to identify a noise location; and
estimate a TD noise of a noise identified in the window.

7. The BS of claim 1, wherein the processor is further configured to:
identify a power delay profile (pdp) vector;
identify a noise window length using a coefficient associated with a noise power;
identify, based on the noise window length, the pdp vector in an ascending order; and
estimate a TD noise of a noise identified based on the noise window length and the ascending ordered pdp vector.

8. The BS of claim 6, wherein the processor is further configured to:
shift the pdp vector to a center position in a fast Fourier transform (FFT) shift operation to estimate a timing offset (TO) value; and
compensate, based on the estimated TO value, a power delay profile.

9. The BS of claim 1, wherein:
the processor is further configured to remove, a noise power based on a refinement window; and
the refinement window is identified based on a last sample in a first half (L_{head}) and a first sample in a second half (N_{fft}−Lₜₐᵢₗ).

10. The BS of claim 9, wherein the processor is further configured to:
enable, based on the refinement window, an artificial intelligence (AI) functional entity using a power delay profile (pdp) vector and the estimated noise power; and
identify, based on the AI functional entity, a time domain minimum mean square error (TD MMSE) filter.

11. A method of a base station (BS) in a wireless communication system, the method comprising:
receiving, from a user equipment (UE) via a set of antennas, uplink signals including at least one of sounding reference signals (SRSs) or demodulation reference signals (DMRs);
identifying time-domain channel estimation (TDCE) for each of the uplink signals, wherein a noise power is estimated to identify the TDCE;
removing a noise floor from the identified TDCE; and
performing, based on the estimated noise power and an estimated signal-to-noise ratio (SNR), an operation to obtain normalized mean square error (NMSE) for the TDCE.

12. The method of claim 11, further comprising performing a threshold-based adaptive TD windowing operation for the identified TDCE after removing the noise floor from the identified TDCE.

13. The method of claim 12, further comprising detecting, based on the threshold-based adaptive TD windowing operation, a channel signal location in a wide range channel with a noise.

14. The method of claim 12, further comprising identifying a channel coefficient based on a threshold associated with a length of an adaptive window for the threshold-based adaptive TD windowing operation.

15. The method of claim 11, further comprising estimating, based on the noise power, the SNR for each of the TDCE using a plurality of parallel signal processing functional blocks in multi-input multi-output (MIMO) systems.

16. The method of claim 11, further comprising:
determining a noise window length;
determining, based on the noise window length, a window to identify a noise location; and
estimating a TD noise of a noise identified in the window.

17. The method of claim 11, further comprising:
identifying a power delay profile (pdp) vector;
identifying a noise window length using a coefficient associated with a noise power;
identifying, based on the noise window length, the pdp vector in an ascending order; and
estimating a TD noise of a noise identified based on the noise window length and the ascending ordered pdp vector.

18. The method of claim 16, further comprising:
shifting the pdp vector to a center position in a fast Fourier transform (FFT) shift operation to estimate a timing offset (TO) value; and
compensating, based on the estimated TO value, a power delay profile.

19. The method of claim 11, further comprising removing, a noise power based on a refinement window, wherein the refinement window is identified based on a last sample in a first half (L_{head}) and a first sample in a second half (N_{fft}−Lₜₐᵢₗ).

20. The method of claim 19, further comprising:
enabling, based on the refinement window, an artificial intelligence (AI) functional entity using a power delay profile (pdp) vector and the estimated noise power; and
identifying, based on the AI functional entity, a time domain minimum mean square error (TD MMSE) filter.
